(19) United States
(12) Patent Application Publication
(10) Pub. No.: US 2007/0204157 A1
(43) Pub. Date: Aug. 30, 2007

(54) Method and apparatus for using out of band captured protocol traffic to facilitate in band traffic capturing

(75) Inventor: Michael Romm, Sunnyvale, CA (US)

Correspondence Address: LECROY CORPORATION, 700 CHESTNUT RIDGE ROAD, CHESTNUT RIDGE, NY, 10977, US

(73) Assignee: LECROY CORPORATION

(21) Appl. No.: 11/702,304

(22) Filed: Feb. 5, 2007

Related U.S. Application Data
(60) Provisional application No. 60/771,188, filed on Feb. 7, 2006.

(51) Int. Cl. H04L 9/00

(52) U.S. Cl. 713/168

(57) ABSTRACT

A method and apparatus for processing electronic data are provided. The method comprises the steps of receiving an out of band data transmission and processing the out of band data transmission to retrieve a Connection Context Information key in substantially real time. Thereafter, an in band data transmission is received and processed employing the encryption key in substantially real time.

### CROSS-REFERENCE TO RELATED APPLICATION

This application claims the benefit under 35 USC 119(e) of U.S. Provisional Patent Application No. 60/771,188, filed Feb. 7, 2006 titled Method for Using Out-Of-Band Captured Protocol Traffic to Facilitate In-Band Traffic Capturing.

### FIELD OF THE INVENTION

This invention is related generally to the capturing, recording and analyzing of Certified Wireless USB (“WUSB”) transmissions between devices, and more particularly to a portable or other Ultra-Wideband (UWB) test and debug platform that preferably combines non-intrusive recording with extensive decoding features.

### BACKGROUND OF THE INVENTION

Ultra-Wideband Technology

UWB technology has been available for over 40 years for military and civilian applications and was originally referred to as either impulse radio or carrier-free communications. More recently, the FCC definition for UWB includes any radio technology with a spectrum that occupies greater than 20 percent of the center frequency or a minimum of 500 MHz. In 2002, the FCC allocated unlicensed radio spectrum from 3.1 GHz to 10.6 GHz expressly for enterprise and consumer applications. The FCC defined a specific minimum bandwidth of 500 MHz at a −10 dB level. As current UWB implementations allow communication that requires high data rates over short distances, one immediate UWB application is WPAN (Wireless Personal Area Network).

Multi-band OFDM technology, promoted by the WiMedia Alliance, is one technology that can utilize the allocated band for UWB. The MB-OFDM transmits data simultaneously over multiple carriers spaced apart at precise frequencies. This approach provides benefits like high spectral flexibility and resiliency to RF interference and multi-path effects. These WiMedia UWB specifications are available from the WiMedia Alliance. The URL for the WiMedia website is http://www.wimedia.org

WiMedia UWB Specification Ecosystem

The WiMedia Alliance has developed specifications for ultra-wide-band (UWB) devices. The main goal of the WiMedia UWB specifications is to create a UWB “ecosystem” that allows easy and secure operation and interoperation of UWB devices. The WiMedia UWB specifications have a first-generation data rate of 480 Mbps, which enables a multitude of innovative wireless devices. UWB devices that follow the WiMedia UWB specifications can co-exist in the same physical environment, even if they have unrelated applications.

The WiMedia UWB specification first-generation data rate of 480 Mbps provides a basis for delivering WUSB devices that can perform comparably with USB 2.0 devices. The Certified Wireless-USB protocol maintains the same host-device model as the wired USB protocol, but the Certified Wireless-USB protocol makes many optimizations for operating efficiently on a wireless medium.

The WUSB specification is available from the USB Implementers Forum (USB-IF). The URL for the USB-IF website is: http://www.usb.org/home

As with all electronic devices, there is a need to be able to properly test various devices to confirm that they conform to a desired standard. Further, when in operation, it may be necessary to debug or troubleshoot any communication or operational problems that arise. Therefore it would be beneficial to provide an improved method and apparatus that allow for this type of testing to be performed in accordance with this new standard.

### SUMMARY OF THE INVENTION

Therefore, in accordance with the invention, a test and measurement apparatus and method are provided that provide full protocol decoding and analysis from low-level packets to higher-level protocols like the Wire Adapter transfers Wireless-USB-protocol devices. It is also contemplated that to the extent any other protocol definitions employ similar attributes, the features of the invention would be applicable thereto.

Furthermore, in accordance with a first aspect of the invention, the method and apparatus described herein allow capturing and analyzing in band traffic of a certain data protocol using out of band data of a different protocol.

In accordance with the invention, the inventor has recognized that the WUSB specifications support several security measures that include the “association” (or ‘pairing’) of two devices. The association process provides a device the means to create a common secret, the Connection Context, which is then used to verify and authenticate the peer device. The Connection Context also provides the means to generate a common encryption key without giving away the key to potential eavesdroppers. The encryption key is used later on by each pair of devices, encrypting traffic at the transmitter device and decrypting it back at the receiver device. The Connection Context creation process does not necessarily take place every time two devices try to create a link, but it might change every time the devices are performing an association process.

Two basic association models are supported by the WUSB:

1. In band model—where the association process is performed through the UWB channel.

2. Out of band model—where another type of protocol that is considered to be equivalent or better in security to the in band protocol, is used to perform the association process.

The later method has typically relied on user's action to physically associate two devices, for example, by connecting them momentary through a cable, or by bringing the devices in proximity to each other.

The first association protocol that was defined for the Certified-WUSB specifications is the USB Cable Association. Other potential out-of-band association procedures can use other wired or wireless protocols. An example for an out-of-band wireless protocol that can be used for the association is NFC (near, field communication).

However, as has been recognized by the inventor of the present invention, to be able to decrypt traffic and view decoding of protocol layers that are higher than the WiMedia frames, the protocol is required to be able to decrypt the secured traffic “on-the-fly” (or in substantially “real-time) and track the security keys changes during the recording session. If the out-of-band association procedure is used between two devices-under-test, the analyzer needs to use the association key for decrypting the traffic. There are two methods of providing the association information to the analyzer system:

1. User Input

2. In accordance with the invention, automatic detection by a secondary sub-system (different than the main sub-system designed for capturing and recording in-band traffic), that further allows for real time processing and use of this out of band information.

User input might be cumbersome or completely useless in some cases, when the user does not know in advance the association information. Therefore, in accordance with the invention, the inventor has provided an automated processing system for function in this real time mode.

More particularly, as the WUSB specifications suggest, there is no way for the user to know what the Connection Context information between two devices looks like ahead of time as it is based on randomly generated data. This means also that in a regular usage case the user of, for example, a UWBTracer™ protocol analyzer, from LeCroy Corporation, or other protocol analyzer, needs to have prior knowledge of the Connection Context information that would be used for the association, and input it into the system. This is not always possible, as the connection Context information in regular WUSB implementation is not fixed. Also, eavesdropping only to the in band channel would not provide this information as it may be transmitted only in the out of band channel. Additionally, as recognized by the inventor of the present invention, the use of a separate capturing system for capturing the out of band traffic and extracting the connection connect information, without means to deliver the data in real-time to the in band analyzer (Protocol Data Collector), would result in inability to use the connection context information immediately when the association is established, resulting in inability of decrypting the in band traffic.

The method described in accordance with the invention particularly deals with the out of band (OOB) model. More specifically, the first OOB model as described in accordance with the invention will use a Wired USB channel. Of course, other wired or wireless protocol channels may be employed.

Out of band communication signaling and data refers to all the signaling and data exchange that is performed on a channel that is separated from channels used for the “regular” in band data/information. In band signaling and data refers to the exchange of signaling and data on the same (“main”) channel that the regular data and signaling is using.

Traditionally, all LeCroy Corporation protocol analyzers capture, record and analyze specific communication protocols, requiring, in some cases, preliminary data that is not always known to the user or cannot be retrieved from the in band data traffic (for instance, security keys that allows the analyzer to decrypt secured data traffic). In accordance with the method presented in accordance with the invention, an analyzer system can capture specific portions of data that are exchanged between two or more transceivers on an out of band channel, and then use this data in substantially real-time to capture and decode an in band channel traffic that might be using the same or a completely different protocol.

Still other objects and advantages of the invention will in part be obvious and will in part be apparent from the specification and the drawings.

The invention accordingly comprises the several steps and the relation of one or more of such steps with respect to each of the others, and the apparatus embodying features of construction, combination(s) of elements and arrangement of parts that are adapted to effect such steps, all as exemplified in the following detailed disclosure, and the scope of the invention will be indicated in the claims.

### BRIEF DESCRIPTION OF THE DRAWINGS

For a more complete understanding of the invention, reference is made to the following description and accompanying drawings, in which:

FIG. 1 depicts a logical block diagram for presenting an apparatus and method, and associated data flow in accordance with the present invention.

### DETAILED DESCRIPTION OF THE PREFERRED EMBODIMENTS

In accordance with the invention, references to “analyzing” may be construed as referring to capturing, recording, and analyzing the traffic, but may also refer to merely capturing, analyzing and distilling portions of data that are desired (not necessarily requiring “recording”).

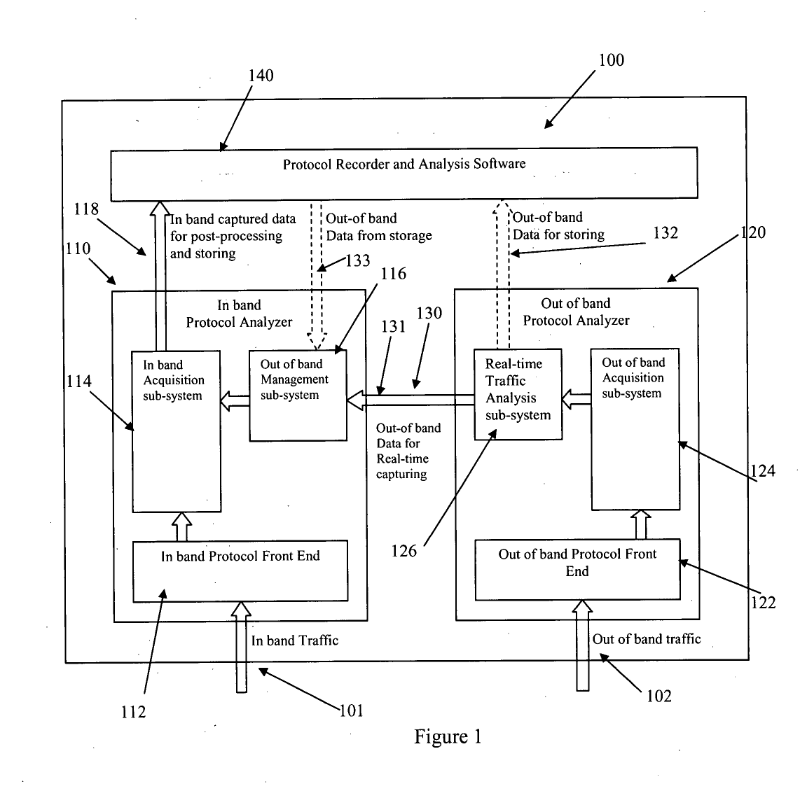

In accordance with the first aspect of the invention, and as shown in FIG. 1, a system 100 constructed in accordance with the invention is shown. System 100 further may comprise two types of protocol analyzers connected through a wired interface, or incorporated into a single system; the first (110) is used for analyzing of a main in band channel and the other (120) is used for analyzing an out of band (OOB) channel. The two analyzers may be connected via a communication connection 130, so that Connection Context information 131, once extracted from the OOB channel by analyzer 120, is delivered to analyzer 110 preferably in substantially real time. This Connection Context information 131 may be used to aid in the processing of the in band information by analyzer 110, allowing recording flow without requiring user interaction.

In a particular preferred embodiment constructed in accordance with the invention, a WUSB/WiMedia UWB protocol analyzer may be employed for the in band traffic analyzer 110 and a wired USB analyzer sub-system (with some modification from a standard system) may be employed for the OOB channel analyzer 120. The OOB channel analyzer 120 further includes an OOB protocol front end 122 for receiving OOB traffic 102, an OOB acquisition subsystem 124 for acquiring OOB traffic 102 from front end 122 (and for determining the precise protocol used to transmit the OOB traffic 102, if the protocol is previously unknown), and a traffic analysis sub-system 126 for acting, preferably in substantially real time, upon OOB traffic 102 received from acquisition subsystem 124. Sub-system 126 is designed to identify and capture the OOB data from traffic 120 that is relevant for use by analyzer 110, and thus extract and/or generate Connection Context information 131. This information 131 is forwarded to analyzer 110 also in substantially real time via connection 130 noted above.

Once appropriate Connection Context information 131 (including at least an encryption key) is captured and detected as such by traffic analysis sub-system 126 from the OOB traffic 102, and forwarded via connection 130 in substantially real time, the information 131 is received by an out of band management sub-system 116 of analyzer 110. Sub-system 116 acts as a Connection Context Management sub-system in analyzer 110, and using the 131 data, is therefore able to track and decrypt in band traffic 101 passing via an in band channel to analyzer 110.

Analyzer 110 further includes an in band protocol front end 112 for receiving in band traffic 101, and an in band acquisition system 114 for acquiring in band traffic 101 received by front end 112. For processing of this acquisition, in band acquisition system 114 employs information 131, including at least a transmitted encryption key, determined by OOB management sub-system 116. After processing, post processed data 118 is forwarded to a protocol reader and analysis subsystem 140, which may comprise a software program, or other hardware and software processing combination. This component post processes the acquired data 118 in any manner desired according to known protocol analyzation techniques and can also store the data for later use.

The ability to process Connection Context Information in substantially real time is important as this information may be changed during processing. Without such real time extraction of the Connection Context Information from the OOB signal, and forwarding the information to Analyzer 110 for use in processing the in band data, such processing may not be possible. Nevertheless, Connection Context information 131 may also be stored as data 132 in subsystem 140 coupled with, or running on the WUSB/UWB analyzer system 100. Therefore, if in band traffic 101 is to be acquired at a later time, in such a later recording session, when the Connection Context Information may be the same, such stored information can be retrieved as data 133 and programmed into OOB management sub-system 116 of analyzer 110 for decrypting in band traffic 101 on the in band channel. Thus, processing can be restarted without requiring a repeat of the OOB acquisition and association process each and every time acquisition of an in band signal is to take place. Thereafter, real time processing as noted above may resume for both the in band data, and OOB information if the Connection Context Information changes.

Therefore, in accordance with a preferred embodiment of the invention, two analyzers are combined and work “automatically” without user data input. Also, the storing of the OOB information allows easy and faster operation over multiple sessions.

This model for processing of OOB and in band data may also be employed for other association models in the future (such as Near Field Communication) and may be applied to other protocols in the future that employ a similar in band and OOB communication configuration.

While the invention has been described applicable to WUSB, the invention is intended to be equally applicable to other protocol definitions and to electronic apparatuses in general.

It will thus be seen that the objects set forth above, among those made apparent from the preceding description, are efficiently attained and, since certain changes may be made in the above construction(s) without departing from the spirit and scope of the invention, it is intended that all matter contained in the above description or shown in the accompanying drawing(s) shall be interpreted as illustrative and not in a limiting sense.

It is also to be understood that the following claims are intended to cover all of the generic and specific features of the invention herein described and all statements of the scope of the invention which, as a matter of language, might be said to fall there between.

What is claimed:

1. A method for processing electronic data, comprising the steps of:
receiving an out of band data transmission;
processing the out of band data transmission to retrieve an encryption key in substantially real time;
receiving an in band data transmission; and
processing the in band data transmission employing the encryption key in substantially real time.

2. The method of claim 1, wherein the in band data transmission complies with a predefined data transmission protocol.

3. The method of claim 2, wherein the predefined data transmission protocol comprises a Certified WUSB transmission protocol.

4. The method of claim 1, wherein the out of band data transmission complies with a data transmission protocol different from a predefined transmission protocol with which the in band data transmission complies.

5. The method of claim 4, wherein the out of band data transmission complies with a wired transmission protocol.

6. The method of claim 5, wherein the wired transmission protocol comprises a wired USB protocol.

7. The method of claim 1, further comprising the step of, after retrieving the encryption key,
storing the encryption key; and
retrieving the encryption key, so that when the in band data transmission is received during a later processing session, the out of band data need not be reprocessed.

8. The method of claim 1, further comprising the step of, after processing the in band data transmission, performing further processing in accordance with protocol analyzation techniques.

9. A system for processing electronic data, comprising:
a first protocol analyzer for receiving an out of band data transmission, and for processing the out of band data transmission to retrieve an encryption key in substantially real time; and
a second protocol analyzer for receiving an in band data transmission, and for processing the in band data transmission employing the encryption key in substantially real time.

10. The system of claim 9, wherein the in band data transmission complies with a predefined data transmission protocol.

11. The system of claim 10, wherein the predefined data transmission protocol comprises a Certified WUSB wireless transmission protocol.

12. The system of claim 9, wherein the out of band data transmission complies with a data transmission protocol different from a predefined transmission protocol with which the in band data transmission complies.

13. The system of claim 12, wherein the out of band data transmission complies with a wired transmission protocol.

14. The system of claim 13, wherein the wired transmission protocol comprises a wired USB protocol.

15. The system of claim 1, further comprising a memory device for storing the encryption key, whereby when the second protocol analyzer receives the in band data transmission a later processing session, the first protocol analyzer need not reprocess the out of band data.

16. The system of claim 9, wherein the first protocol analyzer further comprises:
a front end for receiving the out of band data transmission;
an acquisition sub-system for acquiring the out of band data transmission received by the front end; and
a traffic analysis sub-system for analyzing the acquired out of band data transmission to extract a Connection Context information there from in substantially real time.

17. The system of claim 9, wherein the traffic analysis sub-system acts in substantially real time upon the acquired out of band data transmission.

18. The system of claim 9, wherein the second protocol analyzer further comprises:
an in band front end for receiving the in band data transmission;
an in band acquisition sub-system for acquiring the in band data transmission received by the in band front end; and
an out of band management sub-system for processing the extracted encryption key in substantially real time;
whereby the in band acquisition sub-system acquires the in band data transmission in accordance with the encryption key in substantially real time.

19. A method for processing electronic data transmitted in accordance with a predefined transmission protocol, comprising the steps of:
receiving an out of band data transmission transmitted in accordance with a secure wired data transmission protocol by a first protocol analyzer;
acquiring the out of band data transmission by the first protocol analyzer to acquire the out of band data transmission;
processing the acquired out of band data transmission by the first protocol analyzer to retrieve an encryption key in substantially real time;
receiving an in band data transmission in accordance with a wireless data transmission protocol by a second protocol analyzer;
receiving the encryption key from the first protocol analyzer by the second protocol analyzer in substantially real time; and
acquiring the in band data transmission by the second protocol analyzer employing the encryption key in substantially real time.

20. The method of claim 19, further comprising the step of, by the first protocol analyzer, determining the secure wired data transmission protocol from the out of band data transmission.
